(19) United States
(12) Patent Application Publication
(10) Pub. No.: US 2017/0224166 A1
(43) Pub. Date: Aug. 10, 2017

(54) FOOD BLENDING SYSTEM

(71) Applicant: Vela Blend, Inc., Gilbert, AZ (US)

(72) Inventors: Matthew Sedlacek, Gilbert, AZ (US); Joseph Velasquez, Scottsdale, AZ (US); Angie Nguyen, Tempe, AZ (US); Yu Liu, Chandler, AZ (US)

(21) Appl. No.: 15/417,091

(22) Filed: Jan. 26, 2017

Related U.S. Application Data
(60) Provisional application No. 62/291,757, filed on Feb. 5, 2016.

(51) Int. Cl. A47J 43/046; B67D 7/02; B67D 7/14

(52) U.S. Cl. CPC A47J 43/046; B67D 7/14; B67D 7/02

(57) ABSTRACT

Food blending can include maintaining a reservoir for holding a liquid for use in blending a set of food ingredients; and dispensing the liquid from the reservoir into a container for blending the food ingredients in the food blending system.

### CROSS-REFERENCE TO RELATED APPLICATIONS

This application claims priority from U.S. Provisional Application No. 62/291,757, filed on 5 Feb. 2016, entitled “HOT/COLD FOOD BLENDING SYSTEM AND METHOD”. Application No. 62/291,757 is incorporated by reference herein, in its entirety, for all purposes.

### BACKGROUND

A food blender can include mechanisms for blending food ingredients. For example, a food blender can include a container and a blending mechanism for blending food ingredients inside the container. A user of a food blender can add food ingredients to the container, pour liquid into the container, and then press switches on the food blender to blend the food ingredients inside the container.

### SUMMARY

In general, in one aspect, the invention relates to a food blending system. The food blending system can include: a reservoir for holding a liquid for use in blending a set of food ingredients; and a mechanism for dispensing the liquid from the reservoir into a container for blending the food ingredients in the food blending system.

In general, in another aspect, the invention relates to a method for food blending. The method can include: maintaining a reservoir for holding a liquid for use in blending a set of food ingredients; and dispensing the liquid from the reservoir into a container for blending the food ingredients in the food blending system.

Other aspects of the invention will be apparent from the following description and the appended claims.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 shows a food blending system in one or more embodiments.

FIG. 2 shows an embodiment of a food blending system in which liquid is dispensed in response to a code imparted onto a package of food ingredients.

FIG. 3 shows an embodiment of a food blending system that includes a reservoir for holding a hot liquid and a reservoir for holding a cold liquid.

FIGS. 4a-4b show an embodiment of a food blending system that includes a pump for dispensing a hot liquid and a pump for dispensing a cold liquid.

FIG. 5 illustrates a container in one or more embodiments of a food blending system.

FIG. 6 illustrates a control system in one or more embodiments of a food blending system.

FIG. 7 is an exploded view of a food blending system in one or more embodiments.

FIG. 8 shows another embodiment of a food blending system.

FIG. 9 illustrates an automatic blending mode of operation of a food blending system in one or more embodiments.

FIG. 10 illustrates a method for food blending in one or more embodiments.

### DETAILED DESCRIPTION

Reference will now be made in detail to the various embodiments of the present disclosure, examples of which are illustrated in the accompanying drawings. Like elements in the various figures are denoted by like reference numerals for consistency. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, have not been described in detail so as not to unnecessarily obscure aspects of the present disclosure.

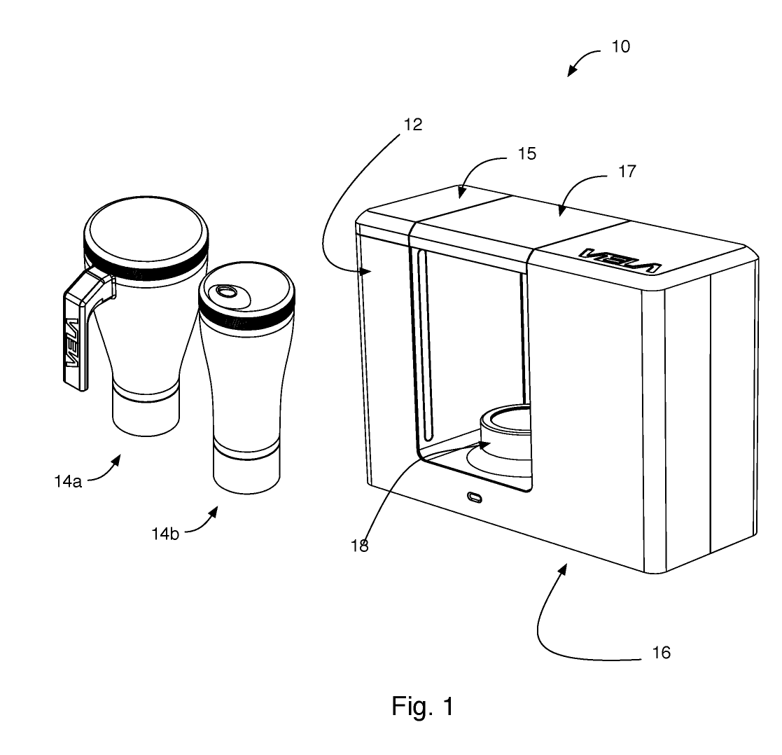

FIG. 1 shows a food blending system 10 in one or more embodiments. The food blending system 10 includes a reservoir 12 for holding a liquid for use in blending a set of food ingredients. The food blending system 10 includes a mechanism 16 for dispensing the liquid from the reservoir 12 into a container 14a-b for blending a set of food ingredients in the food blending system 10.

In one or more embodiments, the food blending system 10 includes an attachment base 18 for the container 14a-b. The mechanism 16 for dispensing the liquid from the reservoir 12 into the container 14a-b can include one or more pumps for pumping the liquid into the container 14a-b when the container is placed in the attachment base 18.

In one or more embodiments, the food blending system 10 includes a reservoir lid 15 that facilitates adding liquid to the reservoir 12. In one or more embodiments, the food blending system 10 includes a receiving space lid 17 that facilitates placement and removal of the container 14a-b into and out of the attachment base 18.

In one or more embodiments, the mechanism 16 for dispensing the liquid from the reservoir 12 into the container 14a-b includes a mechanism for controlling an amount of the liquid dispensed into the container 14a-b. For example, the mechanism 16 can include one or more sensors for sensing an amount of the liquid dispensed from the reservoir 12 into the container 14a-b, and one or more pumps that pump the liquid from the reservoir 12 into the container 14a-b. The mechanism 16 can control the flow of the liquid from the reservoir 12 into the container 14a-b in response to data from the sensors that sense the amount of liquid dispensed from the reservoir 12 into the container 14a-b.

In one or more embodiments, the mechanism 16 for dispensing the liquid from the reservoir 12 into the container 14a-b includes a mechanism for controlling a temperature of the liquid dispensed into the container 14a-b. For example, the mechanism 16 can include a heating mechanism and one or more temperature sensors for sensing a temperature of the liquid dispensed from the reservoir 12 into the container 14a-b. The mechanism 16 can control the flow of the liquid from the reservoir 12 into the container 14a-b in response to temperature data from the temperature sensors.

In one or more embodiments, the mechanism 16 for dispensing the liquid from the reservoir 12 into the container 14a-b includes a mechanism for controlling an amount of the liquid dispensed into the container 14a-b in response to a setting obtained from a user. For example, the mechanism 16 can include an interface, e.g., LED, touchscreen, etc., that enables a user to provide a setting for an amount of the liquid dispensed into the container 14a-b.

In one or more embodiments, the mechanism 16 for dispensing the liquid from the reservoir 12 into the container 14a-b includes a mechanism for controlling a temperature of the liquid dispensed into the container 14a-b in response to a setting obtained from a user. For example, the mechanism 16 can include an interface, e.g., LED, touchscreen, etc., that enables a user to provide a setting for a temperature of the liquid dispensed into the container 14a-b.

In one or more embodiments, the mechanism 16 for dispensing the liquid from the reservoir 12 into the container 14a-b includes a mechanism for controlling an amount of the liquid dispensed into the container 14a-b in response to a preprogrammed setting. For example, the mechanism 16 can include a controller with one or more preprogrammed settings for controlling an amount of the liquid dispensed into the container 14a-b.

In one or more embodiments, the mechanism 16 for dispensing the liquid from the reservoir 12 into the container 14a-b includes a mechanism for controlling a temperature of the liquid dispensed into the container 14a-b in response to a preprogrammed setting. For example, the mechanism 16 can include a controller with one or more preprogrammed settings for controlling a temperature of the liquid dispensed into the container 14a-b.

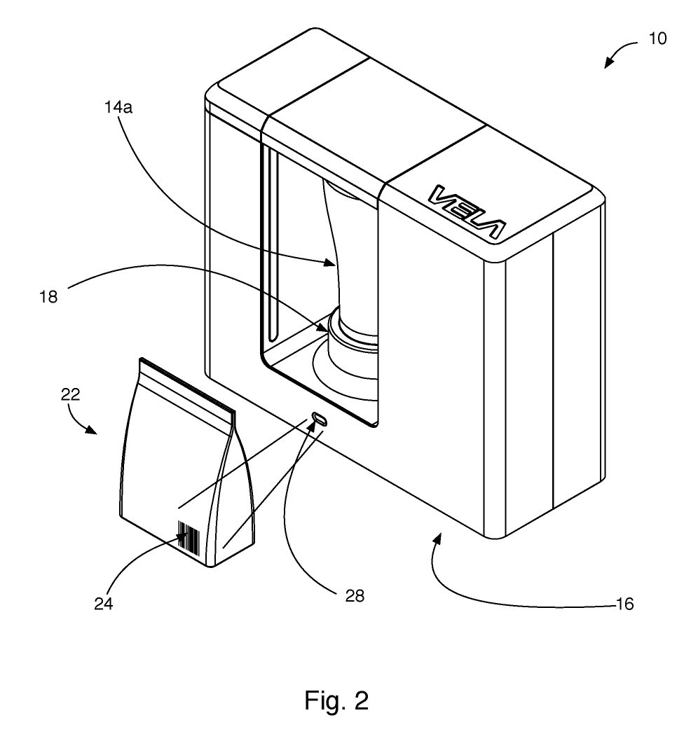

FIG. 2 shows an embodiment of the food blending system 10 in which the mechanism 16 for dispensing the liquid from the reservoir 12 into the container 14a-b dispenses the liquid in response to a code imparted onto a package of food ingredients 22. For example, the food blending system 10 can include a code scanner 28 for reading a code designator 24. The code designator 24 can be a bar code, an RFID tag, a QR code, etc.

In one or more embodiments, the mechanism 16 for dispensing the liquid from the reservoir 12 into the container 14a-b includes a mechanism for controlling an amount of the liquid dispensed into the container 14a-b in response to a code imparted onto the package of food ingredients 22. For example, the mechanism 16 can include a controller for reading the code designator 24 via the code scanner 28 and for dispensing an amount of the liquid from the reservoir 12 into the container 14a-b in response to the code designator 24.

In one or more embodiments, the mechanism 16 for dispensing the liquid from the reservoir 12 into the container 14a-b includes a mechanism for controlling a temperature of the liquid dispensed into the container 14a-b in response to a code imparted onto the package of food ingredients 22. For example, the mechanism 16 can include a controller for reading the code designator 24 via the code scanner 28 and dispensing the liquid from the reservoir 12 into the container 14a-b at a temperature derived from the code designator 24.

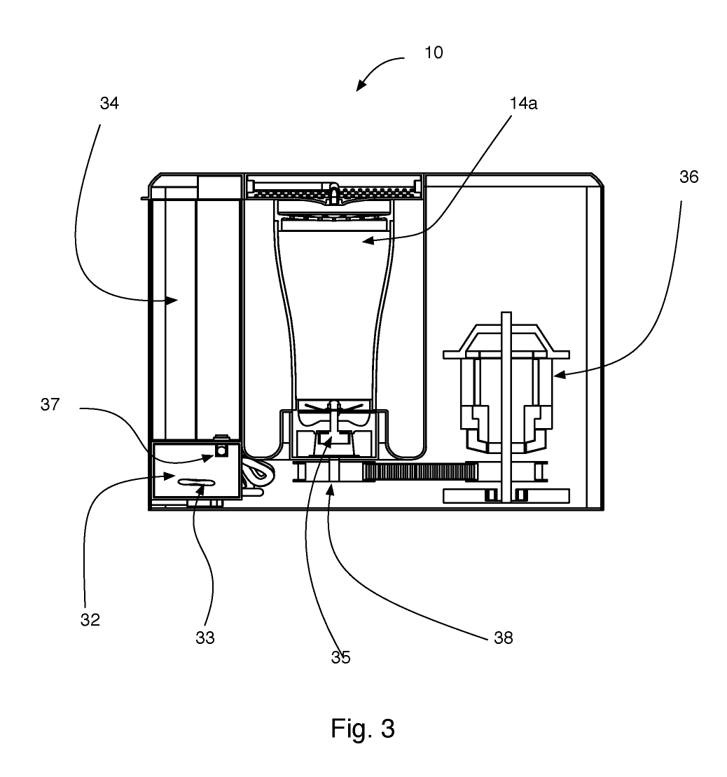

FIG. 3 shows an embodiment of the food blending system 10 in which the reservoir 12 includes a hot reservoir 32 for holding a hot liquid and a cold reservoir 34 for holding a cold liquid. Also shown is a motor 36 and a drive assembly 38 for turning a blade mechanism 35 for blending the food ingredients in the container 14a, and a heating element 33, e.g., a submerged heating coil, for heating the liquid in the hot reservoir 32.

In one or more embodiments, the food blending system 10 includes a check valve 37 that enables liquid to pass from the cold reservoir 34 into the hot reservoir 32 when the level of liquid in the hot reservoir 32 falls below a predetermined level. For example, the check valve 37 can include a float mechanism that opens when the level of liquid in the hot reservoir 32 is too low.

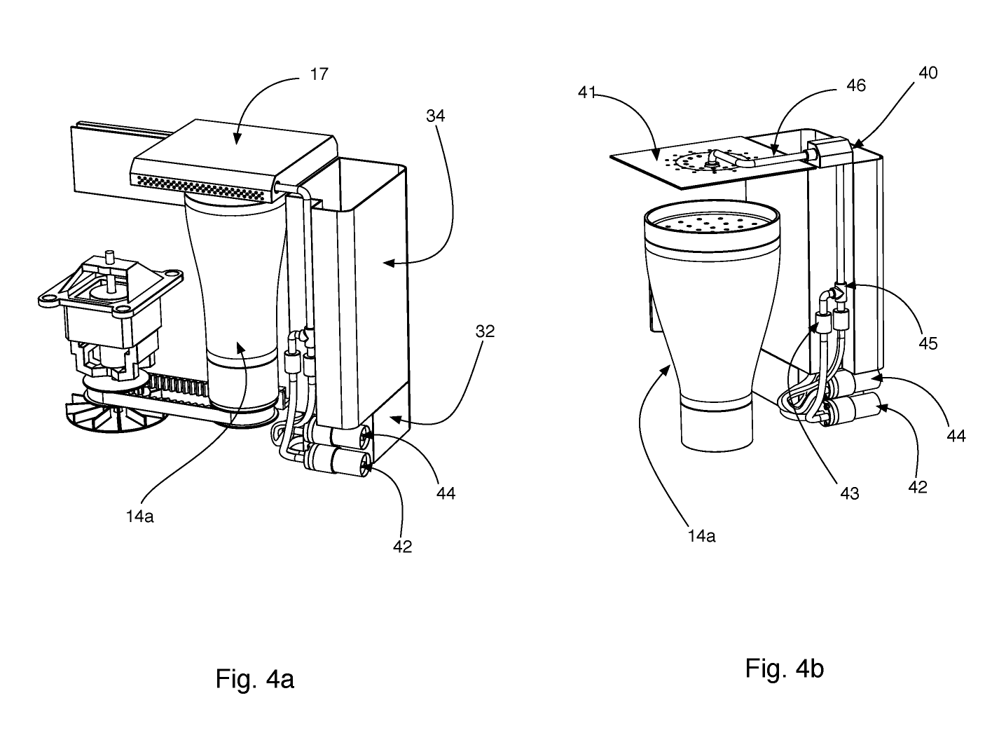

FIGS. 4a-4b show an embodiment of the food blending system 10 that includes a hot pump 42 for moving the hot liquid from the hot reservoir 32 into the container 14a, and a cold pump 44 for moving the cold liquid from the cold reservoir 34 into the container 14a. In one or more embodiments, the hot liquid from the hot reservoir 32 and the cold liquid from the cold reservoir 34 can be routed into the container 14a via a conduit 46.

In one or more embodiments, the food blending system 10 includes a flow sensor 45 for sensing the amount of liquid dispensed into the container 14a. Respective conduits that feed the conduit 46 can each have a filter in line, e.g., a filter 43. A liner 41 of the receiving space lid 17 can include perforations that allow steam to pass through the liner 41. A swivel joint 40 can enable opening and closing of the receiving space lid 17.

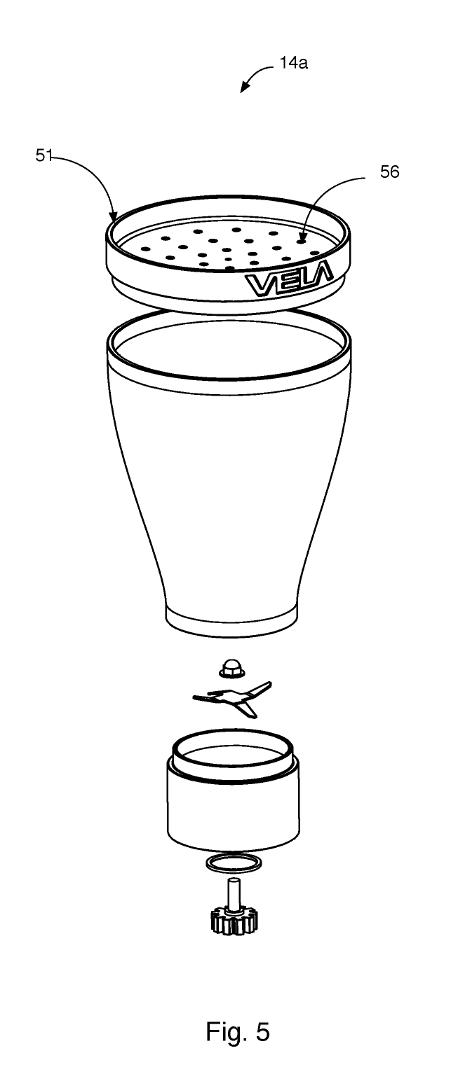

FIG. 5 illustrates the container 14a in one or more embodiments. The container 14a includes a container lid 51. The container lid 51 includes a set of apertures, e.g. an aperture 56. The apertures in the container lid 51 can provide a substantially even dispersion of hot liquid over the food ingredients in the container 14a and facilitate thawing of frozen food ingredients in the container 14a.

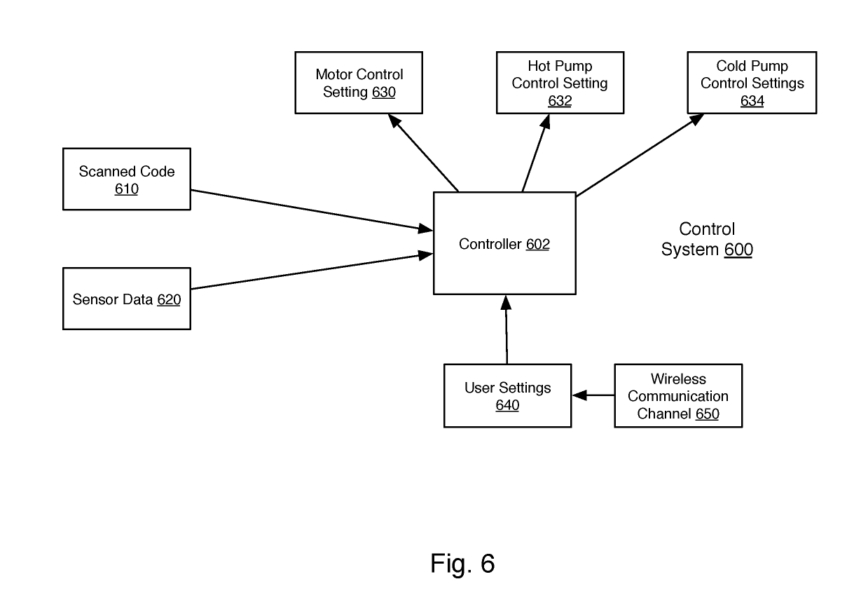

FIG. 6 illustrates a control system 600 in one or more embodiments of the food blending system 10. The control system 600 includes a controller 602 that orchestrates the operations of the food blending system 10 in response to a scanned code 610, a set of sensor data 620, and a set of user settings 640.

The scanned code 610 can be a package code scanned from a package containing the food ingredients to be processed in the container 14a-b. For example, the scanned code 610 can be scanned from the code designator 24 on the package of food ingredients 22.

The sensor data 620 can include data from temperature sensors for sensing the temperature of liquid dispensed into the container 14a-b. The sensor data 620 can include measurements from flow sensors for sensing an amount of liquid dispensed into the container 14a-b. The sensor data 620 can include indications from sensors for detecting whether or not the container 14a-b is securely placed in that attachment base 18, and whether or not the receiving space lid 17 is properly closed.

The user settings 640 can be inputs from a user that pertain to a temperature of the liquid to be used for blending the food ingredients in the container 14a-b. The user settings 640 can be inputs from a user that pertain to an amount of liquid to be used for blending the food ingredients in the container 14a-b. The user settings 640 can be inputs from a user that pertain to blending timing and speed for blending the food ingredients in the container 14a-b. The user settings 640 can be obtained, e.g., via a user interface mechanism of the food blending system 10 or a wireless communication channel 650.

In one or more embodiments, the controller 602 controls the motor 36 by generating a set of motor control settings 630. For example, the motor control settings 630 can control motor speed and timing of activation of the motor 36.

In one or more embodiments, the controller 602 controls the hot pump 42 by generating a set of hot pump control settings 632, and controls the cold pump 44 by generating a set of cold pump control settings 634. For example, the hot pump control settings 632 can control the timing of activation of the hot pump 42. Likewise, the cold pump control settings 634 can control the timing of activation of the cold pump 44.

The controller 602 can maintain one or more preprogrammed settings for one or more of the motor control settings 630, the hot pump control settings 632, and the cold pump control settings 634. For example, preprogrammed settings can be selected by the user via the user settings 640.

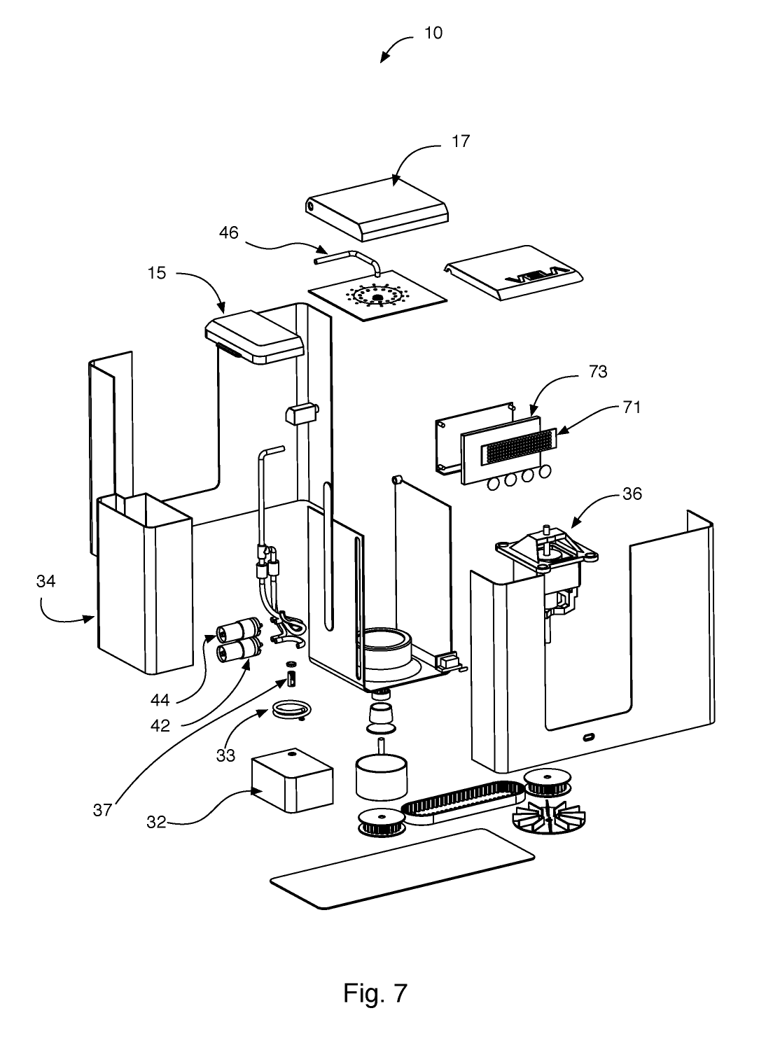

FIG. 7 is an exploded view of the food blending system 10 in one or more embodiments. A user interface mechanism 71 displays information to a user and obtaining inputs from a user, e.g., the user settings 640. The user interface mechanism 71 can include LEDs, a touchscreen, buttons, etc. A circuit board 73 includes the controller 602.

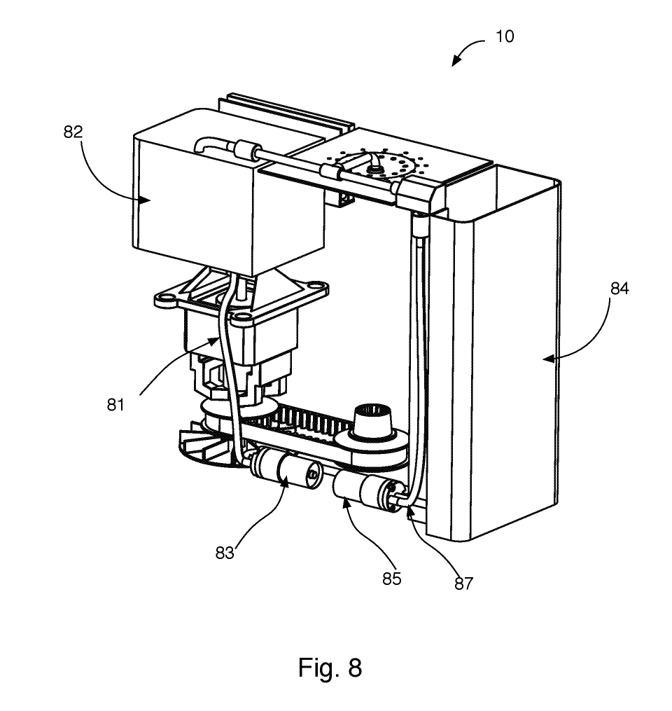

FIG. 8 shows an embodiment of the food blending system 10 with an alternative arrangement of the reservoir 12. In this embodiment, the reservoir 12 includes a hot reservoir 82 for holding a hot liquid and a cold reservoir 84 for holding a cold liquid. For example, the hot reservoir 82 can include a submerged heating coil for heating the liquid in the hot reservoir 82. A pump 83 and a conduit 81 can dispense liquid from the hot reservoir 82 into the container 14a-b, and a pump 85 and a conduit 87 can dispense liquid from the cold reservoir 84 into the container 14a-b. The controller 602 can activate the pump 85 to fill the hot reservoir 82 from the cold reservoir 84 via the conduit 87 and the conduit 81 when the controller 602 senses the level of liquid in the hot reservoir 82 is too low.

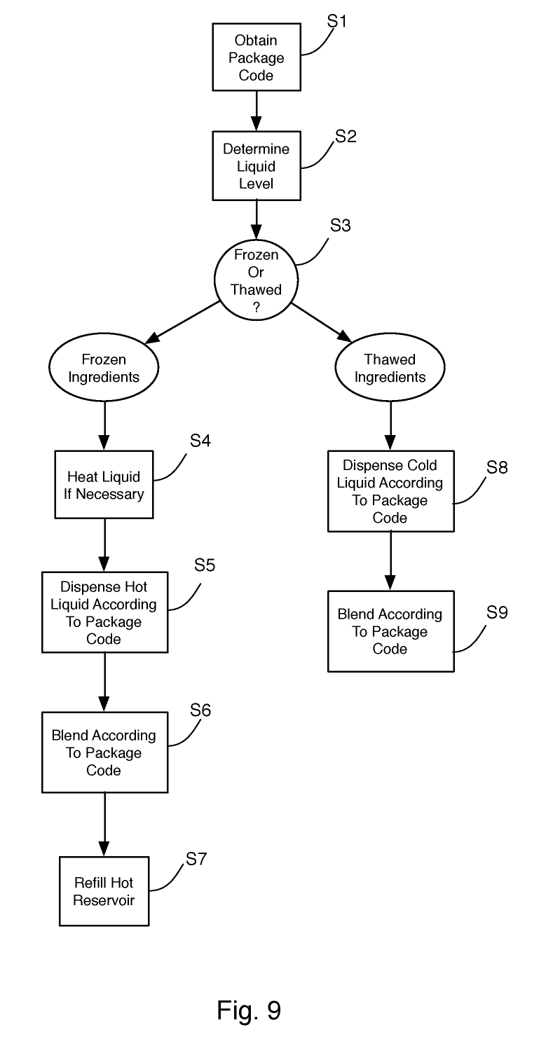

FIG. 9 illustrates an automatic blending mode of operation of the food blending system 10 in one or more embodiments. The process steps S1-S9 in one or more embodiments can be undertaken by the controller 602 when automatically processing the contents of the package of food ingredients 22.

At step S1, a package code is obtained for the package of food ingredients 22. For example, a package code scan be scanned from the code designator 24 of the package of food ingredients 22 using the code scanner 28.

At step S2, an amount of liquid in the reservoir 12 is determined. If the amount of liquid in the reservoir 12 at step S2 is not sufficient to process the package of food ingredients 22, a user can be prompted to add more liquid at step S2. For example, the user can be prompted via the user interface mechanism 71. Step S2 can include checking for proper positioning of the container 14a-b in the attachment base 18 and proper closing of the receiving space lid 17. Step S2 can include prompting a user to properly position the container 14a-b in the attachment base 18 or properly close the receiving space lid 17 when needed.

At step S3, it is determined whether the food ingredients being processed are frozen or thawed. For example, a user can be prompted via the user interface mechanism 71 to indicate either “frozen” or “thawed”. Steps S4-S7 are performed for frozen food ingredients, and steps S8-S9 for thawed food ingredients.

At step S4, a supply of liquid is heated if necessary. For example, the supply of liquid in the hot reservoir 32 can be heated by activating the heating element 33 if a temperature sensor indicates that the temperature of the liquid in the hot reservoir 32 is too low. The liquid in the hot reservoir 32 can be heated to boiling point at step S4.

At step S5, an amount of hot liquid is dispensed into the container 14a-b according to the package code from the package of food ingredients 22. For example, the package code from the package of food ingredients 22 can map to an amount of hot liquid and the hot pump 42 can be activated until flow sensors indicate that an appropriate amount of hot liquid has been dispensed into the container 14a-b.

At step S6, the food ingredients and hot liquid in the container 14a-b are blended according to the package code from the package of food ingredients 22. For example, the package code from the package of food ingredients 22 can map to parameters for the motor 36 that drive the drive assembly 38 and the blade mechanism 35. Parameters for the motor 36 can include speed, rate, blend time, etc.

At step S7, the liquid in the hot reservoir 32 is refilled in preparation for the next cycle. For example, the pump 85 can pump liquid from the cold reservoir 84 into the hot reservoir 82 in the embodiment of FIG. 8.

At step S8, an amount cold liquid is dispensed into the container 14a-b according to the package code from the package of food ingredients 22. For example, the package code from the package of food ingredients 22 can map to an amount of liquid and the cold pump 44 can be activated until flow sensors indicate that an appropriate amount of cold liquid has been dispensed into the container 14a-b.

At step S9, the food ingredients and liquid in the container 14a-b are blended according to the package code from the package of food ingredients 22. For example, the package code from the package of food ingredients 22 can map to parameters for the motor 36.

In one or more embodiments, the food blending system 10 includes a cleaning mode in which the controller 602 can prompt the user to add a cleaning agent, e.g., vinegar, to the reservoir 12 for an automatic cleaning cycle of the food blending system 10.

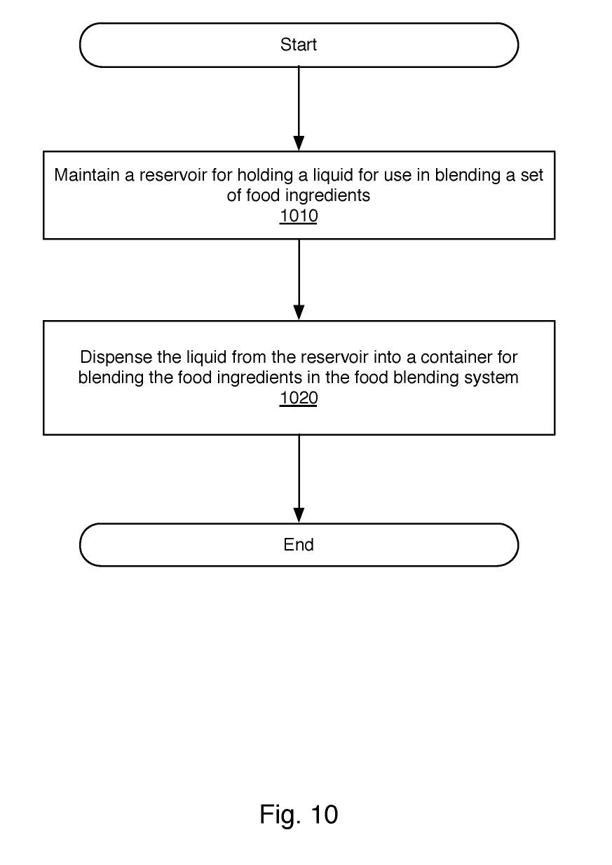

FIG. 10 illustrates a method for food blending in one or more embodiments. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 10 should not be construed as limiting the scope of the invention.

At step 1010, a reservoir is maintained for holding a liquid for use in blending a set of food ingredients. The reservoir can maintain a hot liquid and a cold liquid for use in blending the food ingredients.

At step 1020, the liquid is dispensed from the reservoir into a container for blending the food ingredients in the food blending system. The liquid can be dispensed to control the amount of liquid and the temperature of the liquid dispensed. The liquid can be dispensed in response to a code read from a package of the food ingredients, in response to user inputs, or using default settings, or any combination.

While the foregoing disclosure sets forth various embodiments using specific diagrams, flowcharts, and examples, each diagram component, flowchart step, operation, and/or component described and/or illustrated herein may be implemented, individually and/or collectively, using a range of processes and components.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While the invention has been described with respect to a limited number of embodiments, those skilled in the art, having benefit of this disclosure, will appreciate that other embodiments may be devised which do not depart from the scope of the invention as disclosed herein.

What is claimed is:

1. A food blending system, comprising:
a reservoir for holding a liquid for use in blending a set of food ingredients; and
a mechanism for dispensing the liquid from the reservoir into a container for blending the food ingredients in the food blending system.

2. The food blending system of claim 1, wherein the mechanism for dispensing comprises a mechanism for controlling an amount of the liquid dispensed into the container.

3. The food blending system of claim 1, wherein the mechanism for dispensing comprises a mechanism for controlling a temperature of the liquid dispensed into the container.

4. The food blending system of claim 1, wherein the mechanism for dispensing comprises a mechanism for controlling an amount of the liquid dispensed into the container in response to a code imparted onto a package of the food ingredients.

5. The food blending system of claim 1, wherein the mechanism for dispensing comprises a mechanism for controlling a temperature of the liquid dispensed into the container in response to a code imparted onto a package of the food ingredients.

6. The food blending system of claim 1, wherein the mechanism for dispensing comprises a mechanism for controlling an amount of the liquid dispensed into the container in response to a setting obtained from a user.

7. The food blending system of claim 1, wherein the mechanism for dispensing comprises a mechanism for controlling a temperature of the liquid dispensed into the container in response to a setting obtained from a user.

8. The food blending system of claim 1, wherein the mechanism for dispensing comprises a mechanism for controlling an amount of the liquid dispensed into the container in response to a preprogrammed setting.

9. The food blending system of claim 1, wherein the mechanism for dispensing comprises a mechanism for controlling a temperature of the liquid dispensed into the container in response to a preprogrammed setting.

10. The food blending system of claim 1, wherein the reservoir comprises a reservoir for holding a hot liquid and a reservoir for holding a cold liquid.

11. The food blending system of claim 10, wherein the mechanism for dispensing comprises a mechanism for controlling an amount of the hot liquid dispensed into the container and for controlling an amount of the cold liquid dispensed into the container.

12. The food blending system of claim 10, wherein the mechanism for dispensing comprises a mechanism for controlling an amount of the hot liquid dispensed into the container and for controlling an amount of the cold liquid dispensed into the container in response to a code imparted onto a package of the food ingredients.

13. The food blending system of claim 1, wherein the mechanism for dispensing comprises a lid for the container that includes a set of apertures for providing a substantially even dispersion of the liquid over the food ingredients.

14. A method for food blending, comprising:
maintaining a reservoir for holding a liquid for use in blending a set of food ingredients; and
dispensing the liquid from the reservoir into a container for blending the food ingredients in the food blending system.

15. The method of claim 14, wherein dispensing comprises controlling an amount of the liquid dispensed into the container.

16. The method of claim 14, wherein dispensing comprises controlling a temperature of the liquid dispensed into the container.

17. The method of claim 14, wherein dispensing comprises controlling an amount of the liquid dispensed into the container in response to a code imparted onto a package of the food ingredients.

18. The method of claim 14, wherein dispensing comprises controlling a temperature of the liquid dispensed into the container in response to a code imparted onto a package of the food ingredients.

19. The method of claim 14, wherein dispensing comprises controlling an amount of the liquid dispensed into the container in response to a setting obtained from a user.

20. The method of claim 14, wherein dispensing comprises controlling a temperature of the liquid dispensed into the container in response to a setting obtained from a user.

21. The method of claim 14, wherein dispensing comprises controlling an amount of the liquid dispensed into the container in response to a preprogrammed setting.

22. The method of claim 14, wherein dispensing comprises controlling a temperature of the liquid dispensed into the container in response to a preprogrammed setting.

23. The method of claim 14, wherein maintaining comprises maintaining a reservoir for holding a hot liquid and a reservoir for holding a cold liquid.

24. The method of claim 23, wherein dispensing comprises controlling an amount of the hot liquid dispensed into the container and controlling an amount of the cold liquid dispensed into the container.

25. The method of claim 23, wherein dispensing comprises controlling an amount of the hot liquid dispensed into the container and controlling an amount of the cold liquid dispensed into the container in response to a code imparted onto a package of the food ingredients.

26. The method of claim 14, wherein the dispensing comprises dispensing the liquid through a lid for the container that includes a set of apertures for providing a substantially even dispersion of the liquid over the food ingredients.
